(19) United States
(12) Patent Application Publication
(10) Pub. No.: US 2018/0020193 A1
(43) Pub. Date: Jan. 18, 2018

(54) WEARABLE BAND

(71) Applicant: PogoTec, Inc., Roanoke, VA (US)

(72) Inventors: RONALD D. BLUM, RONAOKE, VA (US); JOSHUA A. SCHOENBART, ROANOKE, VA (US); JAMES E. BARNEY, ROANOKE, VA (US); RICHARD CLOMPUS, TRINIDAD, CA (US); WILLIAM KOKONASKI, BELFAIR, WA (US); WALTER DANNHARDT, ROANOKE, VA (US)

(73) Assignee: PogoTec, Inc., Roanoke, VA (US)

(21) Appl. No.: 15/652,780

(22) Filed: Jul. 18, 2017

Related U.S. Application Data
(60) Provisional application No. 62/363,642, filed on Jul. 18, 2016.
(60) Provisional application No. 62/366,909, filed on Jul. 26, 2016.
(60) Provisional application No. 62/369,337, filed on Aug. 1, 2016.
(60) Provisional application No. 62/397,009, filed on Sep. 20, 2016.
(60) Provisional application No. 62/406,087, filed on Oct. 10, 2016.
(60) Provisional application No. 62/419,313, filed on Nov. 8, 2016.
(60) Provisional application No. 62/442,302, filed on Jan. 4, 2017.

(51) Int. Cl. H04N 7/18; H04N 5/225; A44C 5/00; G03B 15/03; G06F 3/01; H04N 5/232; G06F 3/16; G06F 3/0488; G04B 47/06

(52) U.S. Cl. CPC H04N 7/185; H04N 5/23293; H04N 5/23216; H04N 5/2257; H04N 5/2256; H04N 5/2253; A44C 5/0007; G06F 3/16; H04N 5/2252; G03B 15/03; G06F 3/017; G04B 47/06; G06F 3/0488

(57) ABSTRACT

An electronic wearable device comprising a band having an outer surface; a camera assembly comprising a camera and a battery; a base plate having a first surface, wherein the first surface at least in part defines a channel, a second surface, a main body, and a member configured to rotatably couple with the band; and a base coupling member attached to the camera assembly and configured to engage the channel.

### CROSS-REFERENCE TO RELATED APPLICATIONS

This application claims the benefit under 35 U.S.C. 119 of the earlier filing date of U.S. Provisional Application No. 62/363,642 entitled “VERSATILE WRIST BAND AND RING FOR SMALL CAMERA”, filed Jul. 18, 2016. The aforementioned provisional application is hereby incorporated by reference in its entirety, for any purpose.

This application claims the benefit under 35 U.S.C. 119 of the earlier filing date of U.S. Provisional Application No. 62/366,909 entitled “WATCHBAND & SMALL CAMERA”, filed Jul. 26, 2016. The aforementioned provisional application is hereby incorporated by reference in its entirety, for any purpose.

This application claims the benefit under 35 U.S.C. 119 of the earlier filing date of U.S. Provisional Application No. 62/369,337 entitled “SLEEVE FOR WEARABLE BAND”, filed Aug. 1, 2016. The aforementioned provisional application is hereby incorporated by reference in its entirety, for any purpose.

This application claims the benefit under 35 U.S.C. 119 of the earlier filing date of U.S. Provisional Application No. 62/397,009 entitled “ELECTRONIC WEARABLE DEVICE SLEEVE FOR WEARABLE BAND”, filed Sep. 20, 2016. The aforementioned provisional application is hereby incorporated by reference in its entirety, for any purpose.

This application claims the benefit under 35 U.S.C. 119 of the earlier filing date of U.S. Provisional Application No. 62/406,087 entitled “SMART SLEEVE FOR WEARABLE BAND”, filed Oct. 10, 2016. The aforementioned provisional application is hereby incorporated by reference in its entirety, for any purpose.

This application claims the benefit under 35 U.S.C. 119 of the earlier filing date of U.S. Provisional Application No. 62/419,313 entitled “SMART CAMERA MODULE FOR WEARABLE BAND”, filed Nov. 8, 2016. The aforementioned provisional application is hereby incorporated by reference in its entirety, for any purpose.

This application claims the benefit under 35 U.S.C. 119 of the earlier filing date of U.S. Provisional Application No. 62/442,302 entitled “ENHANCED SMART CAMERA MODULE FOR WEARABLE BAND”, filed Jan. 4, 2017. The aforementioned provisional application is hereby incorporated by reference in its entirety, for any purpose.

### TECHNICAL FIELD

The present disclosure relates to a wristband with multiple user features. Examples are described which may facilitate the use of a wristband to accomplish various user-desired tasks.

### BACKGROUND

The number and types of commercially available electronic wearable devices continues to expand.

Generally, a wearable band or wristband may be used for decorative or time telling purposes but is devoid of electronic features.

Moreover, as cameras become increasingly ubiquitous, it is difficult to ensure proper alignment and composition of an image with a camera worn by a user.

### SUMMARY

Examples of methods are described herein which may include an electronic wearable device comprising a band having an outer surface; a camera assembly comprising a camera and a battery; a base plate having a first surface, wherein the first surface at least in part defines a channel, a second surface, a main body, and a member configured to rotatably couple with the band; and a base coupling member attached to the camera assembly and configured to engage the channel.

In some embodiments, the electronic wearable device comprises a memory storage.

In some embodiments, the electronic wearable device comprises a communication component.

In some embodiments, the communication component includes a speaker and a microphone

In some embodiments, the electronic wearable device comprises a level.

In some embodiments, the band further comprises an adjustment feature.

In some embodiments, the camera assembly further comprises a main body.

In some embodiments, the base coupling member is I shaped.

In some embodiments, the camera assembly further comprises a camera module configured to electronically capture a photographic image, and a flash aligned with the camera module.

In some embodiments, the electronic wearable device comprises an operational LED that indicates a status of the camera assembly to a user.

In some embodiments, the electronic wearable device comprises a micro USB connector port configured to transfer data stored within the memory storage to an external electronic device.

In some embodiments, the electronic wearable device comprises a level configured to indicate an alignment of the camera assembly with respect to a ground.

In some embodiments, the member of the base plate extends from the second surface of the base plate and is configured to rotatable couple with a rotatable receiving member positioned on the outer surface of the band.

In some embodiments, the channel of the base plate comprises a first magnetic member that attracts a second magnetic member of the base coupling member of the camera assembly.

In some embodiments, the band is a wristband configured to be positioned around a user's wrist.

In some embodiments, the band is a ring configured to be positioned around a user's finger.

In some embodiments, the band is a watchband with a watch face and configured to be positioned around a user's wrist.

Another example or method of an electronic wearable device comprises a sleeve configured to slidably couple with a band worn by a user; and a camera assembly having a camera positioned on an outer surface of the sleeve, a communication component, and a battery.

In some embodiments, the electronic wearable device comprises a sensor package,

In some embodiments, the sleeve further comprises an inner surface configured to be positioned adjacent the band when the sleeve is slidably coupled to the band.

In some embodiments, the electronic wearable device comprises an operational LED positioned on the outer surface of the sleeve configured to display a first statistic of the camera assembly.

In some embodiments, the communication component comprises a microphone and a speaker.

In some embodiments, the electronic wearable device comprises a sensor package comprises at least one of an accelerometer, a gyroscope, and a pulse sensor.

In some embodiments, the electronic wearable device comprises a screen configured to display a second statistic of the camera assembly.

In some embodiments, the electronic wearable device comprises a memory storage.

In some embodiments, the electronic wearable device comprises a level indicator configured to display alignment information of the camera assembly with respect to a ground.

In some embodiments, the band is a bracelet.

In some embodiments, the band is a watchband.

In some embodiments, the electronic wearable device comprises a connection feature configured to connect the device to an alternate electronic device via a wireless hamlet signal or a Bluetooth signal.

In some embodiments, the sleeve comprises a flexible material configured to adjust to a shape of the band.

Another example or method of an electronic wearable device comprises a camera assembly having a wedge with a top surface and a bottom surface, and a camera module having a horizontal aspect, a vertical aspect, and a sightline generally parallel to the horizontal aspect, wherein the top surface of the wedge forms an acute angle with the sightline; a coupling feature comprising a clip configured to adjustably couple to the housing of the camera assembly; wherein the coupling feature and the camera assembly are configured to couple together about a band.

In some embodiments, the camera assembly further comprises a housing with at least one protrusion that is configured to adjustably couple with the clip.

In some embodiments, the camera assembly further comprises a screen adjacent the top surface of the wedge, and the screen is configured to display a view of a photographic object as positioned within the sight line of the camera module.

In some embodiments, the acute angle is in the range of about 10 degrees to 80 degrees as measured from the sightline.

In some embodiments, the electronic wearable device comprises the acute angle is in the range of about 20 to 60 degrees as measured from the sightline.

In some embodiments, the band is a watchband.

In some embodiments, the band is a bracelet.

In some embodiments, the band is a ring configured to be worn around a user's finger.

In some embodiments, the camera assembly further comprises a micro USB connector port.

### BRIEF DESCRIPTION OF THE DRAWINGS

Features, aspects and attendant advantages of described embodiments will become apparent from the following detailed description, in which:

FIG. 1 is a schematic illustration of an electronic wearable device in the form of a wristband arranged in accordance with examples described herein.

FIG. 2 is a schematic illustration of an electronic wearable device in the form of a ring arranged in accordance with examples described herein.

FIG. 3 is a schematic illustration of a partially exploded electronic wearable device in the form of a watchband arranged in accordance with examples described herein.

FIG. 4 is a schematic illustration of an electronic wearable device in the form of an electronic sleeve arranged in accordance with examples described herein.

FIG. 5 is a schematic illustration of a first view of another example of an electronic wearable device in the form of a wristband arranged in accordance with examples described herein.

FIG. 6 is a schematic, exploded illustration of a first view of an example of a camera coupling feature arranged in accordance with examples described herein.

FIG. 7 is a schematic illustration of another example of a camera coupling feature arranged in accordance with examples described herein.

FIG. 8 is a schematic illustration of another example of a camera coupling feature arranged in accordance with examples described herein.

FIG. 9 is a schematic illustration of a portion of another example of a camera coupling feature arranged in accordance with examples described herein.

FIG. 10 is a schematic illustration of another view of the camera coupling feature of FIG. 5 arranged in accordance with examples described herein.

FIGS. 11A and 11B are a top and bottom isometric schematic illustration of various components of the camera coupling feature of FIG. 5 arranged in accordance with examples described herein

FIG. 12 is a schematic, non-exploded illustration an electronic wearable device in the form of a watch arranged in accordance with examples described herein.

### DETAILED DESCRIPTION

Examples described herein include devices, methods, and systems for electronic wearable devices.

Examples described herein include wristbands which may support (e.g. attach, integrate with) electronic components, such as a camera, battery, communication components, and/or combinations thereof. Attachment mechanisms are described which may allow a camera to mount to a wristband in a rotatable manner, such that the camera may be rotated, for example, to compose an image shoot. Sleeves are also described which may support (e.g. attach, integrate with) electronic components. The sleeve may be positioned over a wristband so as to add functionality to the wristband. In some examples, cameras and displays may be provided for integration with a wristband on an angled wedge. The angled wedge may allow for a user to ensure a camera is pointed in a predetermined direction (e.g., forward) when the user performs a particular gesture (e.g., forearm in front of the user). The angled wedge may allow the user to view the image as seen by the camera on a display which is oriented toward the user's field of view when the particular gesture is performed.

Camera assemblies described herein may include (and/or be in communication with) one or more image capture devices (e.g., one or more cameras) which may capture image and/or video data. For example, camera assemblies described herein may capture video data having an audio component (e.g., using an image capture device and a microphone). The image capture device (e.g., camera) and/or all or portions of camera assemblies described herein may be attachable and/or detachable from a base in order to move the image capture device and/or portions of a camera assembly from one wearable object to another (e.g., from one wristband to another). Data collected using camera assemblies described herein may be communicated (e.g., through a wired or wireless connection) to another computing system continuously, periodically, or sporadically in various examples. Other computing systems may in some examples provide data to camera assemblies described herein.

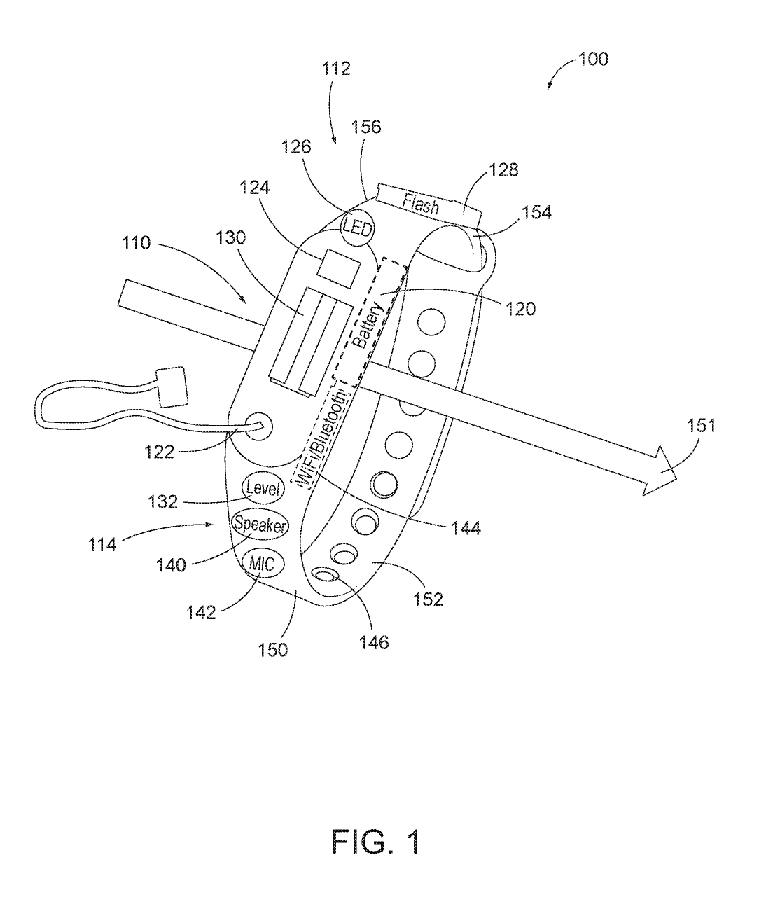

FIG. 1 illustrates an electronic wearable device assembly in the form of a wristband arranged in accordance with examples described herein. The electronic wearable device assembly 100 includes a wristband 110, and a camera assembly 112. In some examples, the camera assembly may be an electronic wearable device. The wristband may form a portion of the electronic wearable device or electronic wearable device assembly. The camera assembly 112 may include comm components 114, a battery 120, a micro USB cable 122, memory storage 124, an operational LED 126, a flash 128, a coupling feature 130, a level 132, and/or any combination of those components. Other components may be included in other examples. Communication or comms components 114 may include a speaker 140, a microphone 142, and a Wi-Fi/Bluetooth connection feature 144. The wristband 110 may also include an adjustment feature 146. A directional arrow 151 may show the alignment of the wristband 110 as worn by a user with respect to various features of the wristband 110.

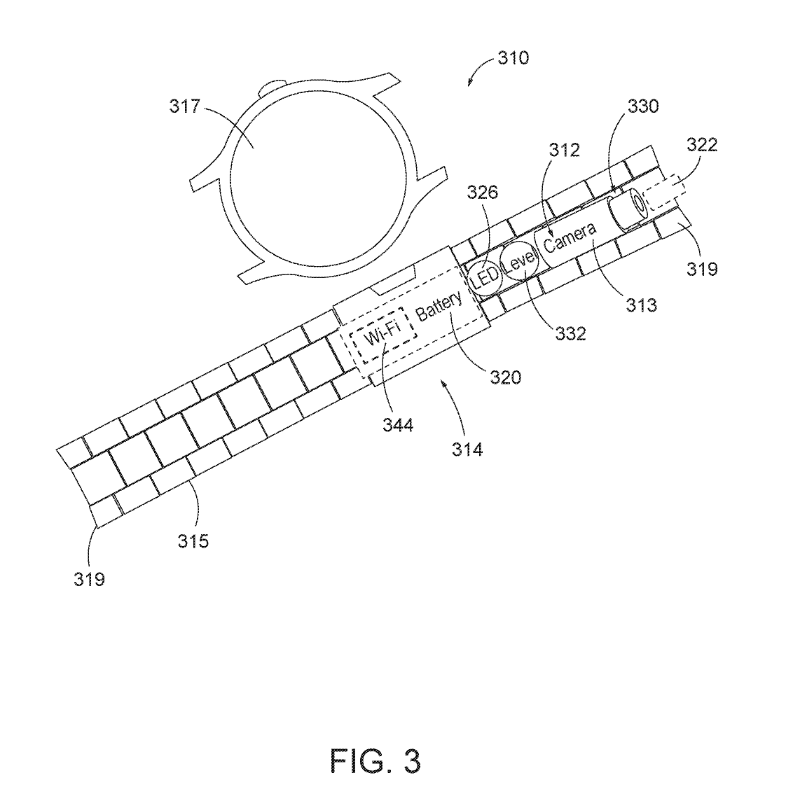

The wristband 110 may be configured to selectively and adjustably couple with various components of the camera assembly 112. In some examples, some components of the camera assembly 112 may be selectively coupled and decoupled from the wristband 110 using the coupling feature 130. These may include a camera (camera 313 in FIG. 3).

In some examples, the comm components 114 may form a wired and/or wireless communication connection to one or more computing systems that electrically connect the camera assembly 112 to an external electronic device, such as a user's smart phone, computer, television, tablet, additional wearable device, automobile, aircraft, and/or appliance. The comm components 114 may include, for example, the Wi-Fi/Bluetooth connection feature 144 to electrically connect the camera assembly 112 to the external electronic device. In some examples, the Wi-Fi/Bluetooth connection feature 144 is another protocol receiver/transmitter.

The comm components 114 may also include the battery 120. The battery 120 may be used to power certain features of the camera assembly 112. The battery 120 may be in the form of a rechargeable battery such as a Nickel-Metal Hydride (NiMH), a Lithium ion (Li-ion), or a Lithium ion polymer (Li-ion polymer) battery. The battery 120 may be operatively coupled to a receiver to store power received wirelessly from a distance separated wireless power transfer system. In some example, the battery 120 may be coupled to energy generator (e.g., an energy harvesting device) of the camera assembly 112. Energy harvesting devices may include, but are not limited to, kinetic-energy harvesting devices, solar cells, thermoelectric generators, or radio-frequency harvesting devices

The camera assembly 112 may include memory storage 124. The memory storage 124 may be implemented using any electronic memory, including but not limited to, RAM, ROM, Flash memory. Other types of memory may be used in other examples. In some examples, the memory storage 124 may store all or portions of images captured by an image sensor of a camera of the camera assembly 112. in some examples, the memory storage 124 may store settings which may be used by the image sensor to capture one or more images. In some examples, the memory storage 124 may store executable instructions which may be executed by a processing unit to perform all or portions of image adjustment techniques that may be used to adjust features of the camera assembly 212.

The camera assembly 112 may be equipped with the input/output connector (e.g., a USB connector such as USB connector 122) for charging the battery 120 of the camera assembly 112 from an external power source and/or for providing power to components of the camera assembly 112 and/or for providing data transfer to/from the camera assembly 112, such as data stored in the memory storage 124. The term USB as used herein may refer to any type of USB interface including micro USB connectors. The USB connector may have a magnet to assist in alignment of a USB cord when coupled to the USB connector 122.

In some examples, the camera assembly 112 may also have a coil configured as a receiver or transmitter coil. The coil may be configured for use in data transmission such as to receive or transmit data. In some examples, the coil may also be used for transmitting or receiving wireless power.

In some examples, the camera assembly 112 may include the flash 128. The flash 128 may be used in conjunction with features of the camera assembly 112 to illuminate a photographic subject.

In some examples, the camera assembly 112 includes the microphone 142. The microphone 142 may be used to electronically record audible wavelengths from a user or the user's surroundings. In some examples, the microphone 142 may be used when the camera assembly 112 is being used to capture an image, and also when the camera assembly 112 is not capturing an image.

In some examples, the camera assembly 112 includes the speaker 140. The speaker 140 may be used to provide audio feedback and electronically emanate audible wavelengths to the user or the user's surroundings. Examples of audible emanations include tonal indicators, words or phrases, music, etc. In some examples, the speaker 140 may be used when the camera assembly 112 is being used to capture an image and also when the camera assembly 112 is not capturing an image. In some examples, the speaker 140 and microphone 142 may form a voice communication system. In some examples, the speaker 140 and microphone 142 form a two-way radio. The speaker 140 may be configured to communicate audio data being transmitted to the device 100 or other devices described herein from another computing system which may be remote from the device 100. Some examples of other computing systems may include but are not limited to a server, a computer, a laptop, a desktop, a smart case, a smart phone, a tablet, a laptop, an automobile, or an appliance.

In some examples, the camera assembly 112 includes a level 132. In some examples, the level 132 is an LED indicator. In some examples, the level 132 is a bubble indicator. The level 132 may be used to indicate the alignment of the camera assembly 112 with respect to the ground. This feature may be desirable for a user to help ensure a camera of the camera assembly 112 is aligned to the user's desires.

In some examples, the camera assembly 112 includes the operational LED 126. The operational LED 126 may optically communicate the status of various features of the camera. assembly 112 to a user. These communications may include the status of the memory storage 124 capacity, the electronic power within the battery 120, the connectivity to an external Wi-Fi or Bluetooth system via the Wi-Fi/Bluetooth feature 144, the proximity of portions of the wristband 110 to a horizontal plane via the level 132, and other features.

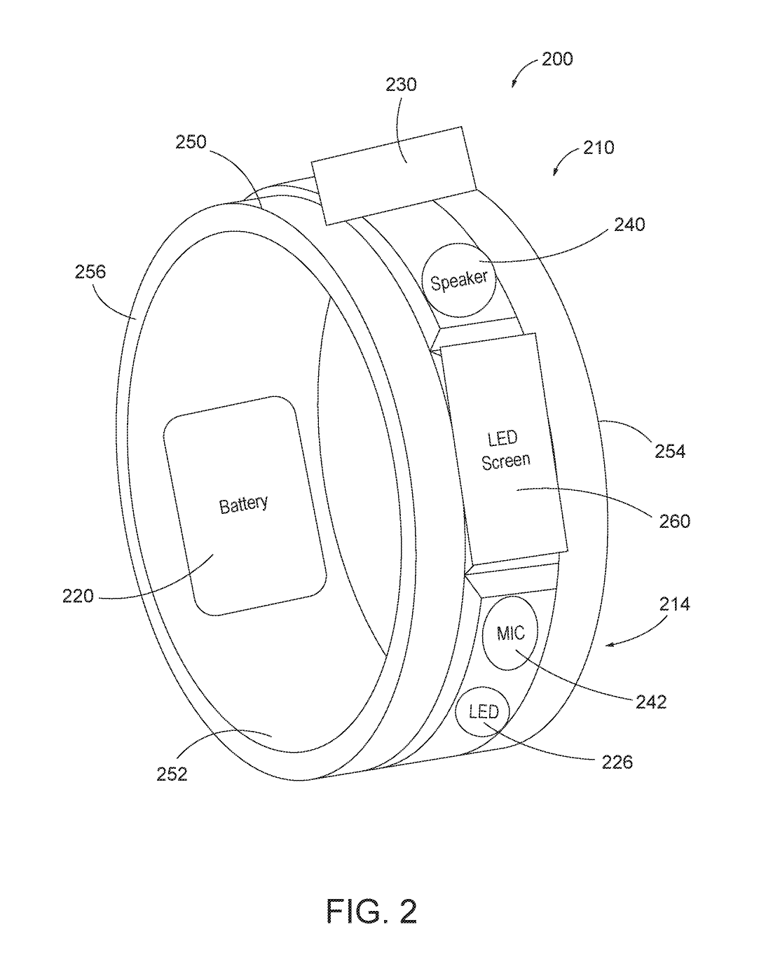

In some examples, the camera assembly 112 includes the coupling feature 130. The coupling feature 130 may he used to selectively adjustably couple components of the camera assembly 112 to the wristband 110. Additional discussion of coupling features is included with reference to FIGS. 2-12, The coupling feature 130 may be configured to interlock portions of the camera assembly 112 to the wristband 110. In some examples, a camera of the camera assembly 112 may be adjustably rotated 90 degrees relative to the wristband 110 using the coupling feature 130. In some examples, a camera of the camera assembly 112 may be adjustably rotated 180 degrees relative to the wristband 110 using the coupling feature 130. In some examples, a camera of the camera assembly 112 may be adjustably rotated 360 degrees relative to the wristband 110 using the coupling feature 130. In some examples, the coupling feature may be configured to rotate within a range of degrees. In some examples, the rotational range may be between generally less than 90 degrees and generally more than 180 degrees.

In some examples, the wristband 110 may also include a screen. The screen may be electrically connected (either hardwire or wireless) to a camera of the camera assembly 112. In some examples, the screen may act as a viewfinder for the camera. The screen may also be used as an input or to adjust features of the camera, such as brightness, contrast, image size, image resolution, etc. The screen may also be used as an indicator to display or visually communicate to a user features or status of the camera and/or camera assembly 112 components. The screen may be used to display options for control of the camera assembly. In some examples, the screen may be an LED, OLED, or LCD screen. The screen may be configured as a touch screen. The screen may be configured to be flexible or bendable. The screen may include a micro-display. In sonic examples, the screen includes a micro-display with generally 400 mm̂2 of surface area or less in a viewable surface area. In some examples, the screen may include a vibrator. In some examples, the wristband includes a vibrator. In some examples, the camera assembly includes a vibrator. In some examples, the vibrator may be configured to attract the attention of a user. For example, the vibrator may alert the user that an image is being, will soon be, or has been captured. The vibrator may alert the user that a video is being, will soon be, or has been captured. The vibrator may alert the user that connectivity is available to another computing system (e.g., so that data may be transmitted from the wristband device to the other computing system). The vibrator may alert the user that a subject is within a field of view of the camera. The vibrator may alert the user to other states in other examples.

In some examples, the camera assembly may be configured to capture a still image or video by a touch of the display. In some examples, the camera assembly may be configured to capture a still image or video by a touch of the camera. In some examples, the camera assembly may be configured to capture a still image or video by way of movement of the wrist of a user. In some examples, the camera assembly may be configured to respond to a voice command by a user or other person or audio data.

In some examples, the coupling feature 130 may be used to permanently couple a camera of the camera assembly 112 to the wristband 110.

In some examples, the wristband 110 is waterproof.

In some examples, the wristband 110 may installed about a user's wrist, hand, neck, finger, head, should, waist, foot, ankle or other bodily appendage. The wristband 110 may circumferentially surround the appendage, and the adjustment feature 146 may be used to adjustably secure the wristband 110 to the appendage. In other examples, the wristband 110 may be secured to an object, such as an article of clothing, a purse handle, a cell phone, a backpack strap, a luggage handle, or similar objects. In some examples, the wristband 110 may act as a safety member.

The wristband 110 may be manufactured from a variety of materials, such as but not limited to, plastic, rubber, metal, leather, and various combinations thereof. In sonic examples, the wristband may be made from material such as a nylon line, a plastic line, a rubber line, a string, a wire, or chain. In some examples the wristband may include a non-electronic watch (e.g. a watch without a processing element, although the watch may have a battery.) In some examples, the wristband is a non-electronic band or bracelet or a dumb band. In some examples, the wristband is an electronic watch. in some examples, the wristband is a smart watch, fitness tracker, activity tracker, connected device, or combinations thereof.

In some examples, portions of the wristband 110 may have an outer surface 150 and an inner surface 152 that are connected by a first edge 154 and a second edge 156. The outer surface 150 may be the surface that forms an outer circumference or perimeter of the wristband 110. The inner surface 152 may be a surface that forms an inner circumference or perimeter of the wristband 110. The inner surface 152 may be positioned adjacent a user when the wristband 110 is worn by the user, The first edge 154 may be generally opposite that of the second edge 156, In some examples, various components of the camera assembly 112 may be positioned adjacent to the outer surface 150. In some examples, various components of the camera assembly 112 may be positioned within the wristband 110.

In some examples, a portion of the flash 128 is positioned adjacent the outer surface 150, the first edge 154, and/or second edge 156. A user may wear the wristband 110 and the light transmitted from the flash 128 may be targeted at a user's photographic subject. In some examples, the flash 128 may be positioned and used as a flashlight. In some examples, the flash 128 may also be used as a safety feature, with intermittent flashes used to identify the location of the flash 128, and therefore the electronic wearable assembly 100 worn on a user, in a dark area.

In some examples, the level 132 is positioned adjacent the outer surface 150, the first edge 154, and/or second edge 156. The user may wear the wristband 110 and be able to view the level 132 to understand the alignment of the wristband 110 with respect to the ground. This may be desirable so that the user may align the wristband 110 to capture an image with the camera assembly 112 at a specific alignment.

In some examples, a portion of the speaker 140 is positioned adjacent the outer surface 150, the first edge 154, and/or second edge 156 to allow for audible wavelengths communicated from the speaker to be easily heard by the user when the wristband 110 is worn by the user.

In some examples, a portion of the microphone 142 is positioned adjacent the outer surface 150, the first edge 154, and/or second edge 156 to allow for the microphone 142 to sense and record audible wavelengths from the user or the user's environment when the wristband 110 is worn by the user. In some examples, the camera assembly may be configured to respond to a voice command by a user or other person or audio data.

In some examples, a portion of the USB connector 122 may be positioned adjacent the exterior surface 149 to allow a user to connect a corresponding cable to the USB connector 122.

In some examples, a portion of the operation LED 126 is positioned adjacent the outer surface 150, the first edge 154, and/or second edge 156 to allow for a user to view the operational LED 126 when the wristband 110 is worn by the user.

In some examples, the memory storage 124 is removable, and the memory storage 124 may be accessed by a user via the exterior surface 149.

In some examples, a portion of the coupling feature 130 is positioned adjacent the outer surface 150, the first edge 154, and/or second edge 156 so that it may be accessed when the wristband 110 is worn by a user. In some examples, a portion of the coupling feature 130 is positioned adjacent the inner surface 152.

A user may use the wristband 110 and camera assembly in a variety of ways—e.g., the wristband and/or and camera assembly may provide a variety of functionalities. Such activities include using a camera for capturing photographic images of a distant removed object or of a user, capturing video of a distant removed object or of the user, telling time, communicating and displaying a weather forecast, communicating and displaying an ambient forecast, determining whether a portion of the wristband is level, monitoring fitness, monitoring the quantity of steps a user takes, monitoring user activity, obtaining electronic inputs, communicating (wirelessly or through a wired connection), cellular phone service, communicating data from a user's cell phone to the wristband, communicating data from a user's laptop or computer to the wristband, communicating data from a user's home security system to the wristband, communicating data from a user's vehicle to the wristband, etc. In some examples, the device is configured as a smart device and configured to communicate wirelessly with a smart phone or mobile computing device and then displays information that may be collected from the computing device that is gathered from, e.g., the internet and/or a cloud storage system.

The wristband 110 may be positioned on a user so that a camera of the camera assembly 112 is directed at a photographic object. The photographic object may be the user themselves, or an object opposite the user. The user may use the appendage the wristband 110 is adjustably coupled with to act as a potential sight or alignment guide to assist in the alignment of the camera with the desired photographic object.

In some examples, the camera assembly 112 may also have a cover configured to cover or protect at least a portion of the camera assembly 112. The cover may be positioned to cover a camera component, screen, lights, etc. based upon the user's desires. The cover may adjustably couple with a portion of the wristband 110, such as by sliding, or by rotation. The cover may be configured to be adjustably moved with respect to the camera assembly 112 or removed entirely. In some examples, the cover may act as an electronic screen, such that it is electrically connected to the camera assembly 112. The cover may be slide away from the camera assembly 112 and then rotated to provide a user wearing the wristband with a better view of the electronic screen.

In some examples, the camera assembly 112 may have a projector. In these examples, the projector may be able to project data stored on the memory storage or camera onto a background. The projector may also be a laser.

In some examples, the camera assembly 112 does not comprise a camera.

The device 100 may contain features and/or components described with respect to other figures.

FIG. 2 is a schematic illustration of an electronic wearable device 200 in the form of a ring 210 arranged in accordance with examples described herein. The electronic wearable device 200 may have similar features and components to the electronic wearable device assembly 100 of FIG. 1. In some examples, the electronic wearable device assembly 200 is the ring 210 with a camera assembly 212. In some examples, the camera assembly may be an electronic wearable device. The camera assembly 212 may have a battery 220, a coupling feature 230. an operational LED 226, and a communication component 214. The communication component 214 may include a speaker 240 and a microphone 242.

The ring 210 may have an outer surface 250 and an inner surface 252 that are connected by a first edge 254 opposite a second edge 256.

In addition, in some examples, the ring 210 may have a screen 260. The screen 260 may be formed by a light emitting diode (LED), an organic light emitting diode (OLED), or an LCD type screen that may display information to a user. The screen 260 may be electrically connected to a camera coupled to the ring 210. An image sensor of a camera coupled to the ring 210 may be electrically connected (hard wire or wirelessly) to the screen 260, so that the screen 260 acts as a view finder.

FIG. 3 is a schematic illustration of a partially exploded electronic wearable device 300 in the form of a watch 310 arranged in accordance with examples described herein. In some examples, the electronic wearable device assembly 300 including the watch 310 of FIG. 3 is similar to the electronic wearable devices assemblies 100, 200 of FIGS. 1 and 2. In some examples, the watch 310 similarly includes a camera assembly 312 having a battery 320, a coupling feature 330, an operational LED 326, a micro USB cable 322, a level, 332, and a communication or comms component 314 with a Wi-Fi/Bluetooth connection feature 344. The camera assembly 312 may also include a camera 313 coupled to the watch 310 via the coupling feature 330. In some examples, the watch 310 may also include a wristband 315 and a watch face 317. The wristband 315 may be connected to the watch face 317 by a plurality of links 319. In some examples, the battery 320 may be used to power various components of the camera assembly 312 and also the watch face 317 components. In some examples, the camera assembly may be an electronic wearable device.

In some examples, the coupling feature 330 may include an aperture extending between the outer surface and inner surface of the wristband 315. In some examples, the camera assembly 312 may be configured to snap within the aperture. In some examples, the camera assembly 312 may be configured to magnetically align and remained positioned within and adjacent to the aperture in the wristband 315 via the coupling feature 330.

In some examples, the coupling feature 330 may include a space between watch links of the wristband 315.

In some examples, the camera assembly 312 may be configured to electronically connect via a wire the camera 313 to the watch face 317. In these examples, the watch face 317 may be a screen, such as an LCD screen, configured to function as a watch face and also display camera images and other status indicators of the camera assembly 312.

In some examples, the camera 313 may be positioned so that it is configured to capture images angled with respect to a plane traveling through the watch face 317. In some examples, the camera 313 may be angled within 45 degrees of the plane traveling through the watch face. In other examples, the camera 313 may be elevated from the camera assembly 312 and the wristband 315 so that the watch face 317 will not block, or influence the image capturing function of the camera 313. In some examples, the camera 313 is configured to be operated by way of touch switch, capacitance switch, audio control, remote control, eye wink, motion or other gesture. In some examples, the display and or camera is touch sensitive, such that examples, the camera assembly may be configured to capture a still image or video by a touch of the display or watch face. In some examples, the camera assembly may be configured to capture a still image or video by a touch of the camera. In some examples, the camera assembly is configured to capture an image responsive to a touch of a display coupled to the camera assembly. In some examples, the camera assembly may be configured to capture a still image or video by way of movement of the wrist of a user. The camera assembly may be configured to be responsive to a wrist, hand, or appendage movement of a user. In some examples, the camera assembly may be configured to respond to a voice command by a user or other person or audio data.

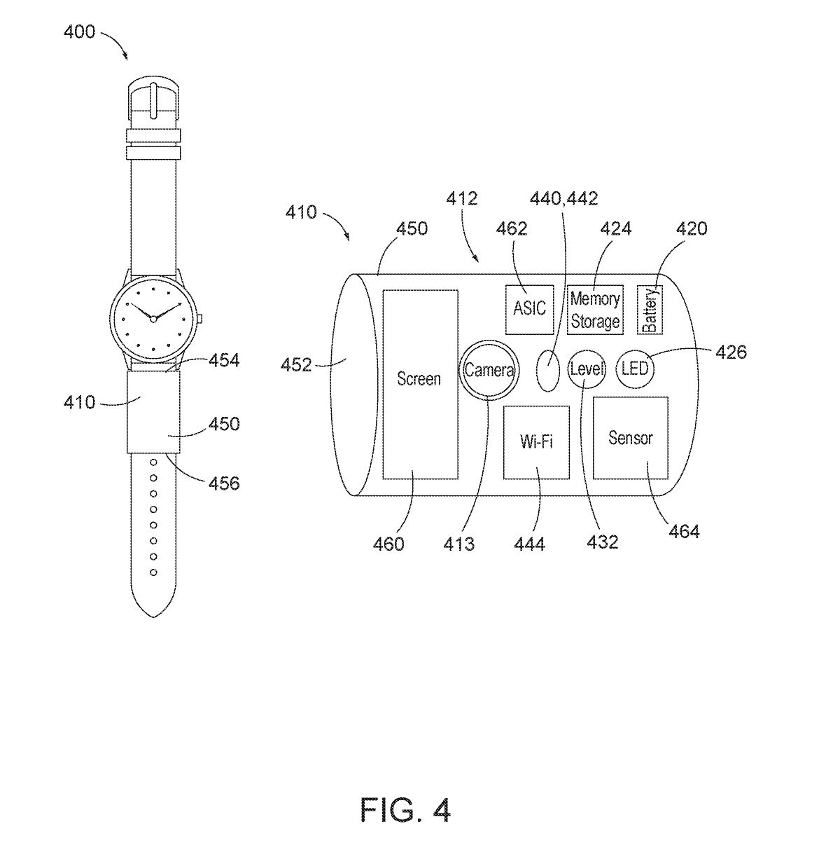

FIG. 4 is a schematic illustration of an electronic wearable device assembly 400 in the form of an electronic sleeve 410 arranged in accordance with examples described herein. In some examples, the electronic wearable device assembly 400 including the electronic sleeve 410 is similar to the electronic wearable device assemblies 100, 200, 300 of FIGS. 1-3. For example, the electronic wearable device 400 may in some examples be used to implement and/or may be implemented by any of the electronic wearable device assemblies 100, 200, 300 of FIGS. 1-3. The electronic sleeve 410 may include a camera assembly 412 having a camera 413 and a memory storage 424, a battery 420, a level indicator 432, a Wi-Fi/Bluetooth connection feature 444, an operational LED 426, a screen 460, and a communication or comms component 414 having a speaker 440 and a microphone 442, in some examples, the sleeve 410 may have an application specific integrated circuit (ASIC) 462 and a sensor package 464. The sensor package 464 may include a variety of sensors such as individual sensor or combination of an accelerometer, acoustic sensor, air pressure sensor, air quality sensor, altimeter, bio sensor, CO sensor, CO2 sensor, electro-mechanical sensor, an EMG sensor, GPS sensor, gyroscope, humidity sensor, infrared sensor, light sensor, mechanical sensor, micro-gyroscope, odor sensor, oxygen sensor, pedometer, pressure sensor, pulse rate sensor, radiation sensor, spectrometer, sweat sensor, temperature sensor, tilt switch, UV sensor, a sensor capable of measuring a base solution, neutral solution, or acidic solution, and/or other sensors. In some examples, the ASIC 462 includes an MCU/MPU. In some examples, the sensor package may include application information and programming configured to calculate a user's caloric expenditures, distance traveled, time slept, and quality of sleep.

The electronic sleeve 410 may have an outer surface 450 and an inner surface 452 connected by a first edge 454 and a second edge 456. In some examples, the electronic sleeve 410 may be cylindrical shaped. In some examples, the electronic sleeve may be rectangular shaped to complement the shape of a wristband, watchband, or bracelet. In some examples, a portion of the electronic sleeve 410 may be made from flexible material to allow the electronic sleeve 410 to be used with a variety of shaped wristbands, watchbands, bracelets, etc. In some examples, the electronic sleeve 410 may have a rigid portion formed of metal, plastic, or other rigid material. In some examples, the sleeve 410 may have a flexible portion. In some examples, the sleeve 410 is formed from rubber, flexible plastic, graphene, borophene, cloth, leather, elastic, or elastic like material.

The electronic sleeve 410 may differ from the electronic wearable device assemblies 100, 200, 300 in that the sleeve 410 is configured to at least partially surround and be positioned adjacent to an existing bracelet, watchband, wristband, ring, ankle band, armband, leg band, or the like. In some examples the wristband may include a non-electronic watch (e.g. a watch without a processing element, although the watch may have a battery.) In some examples, the wristband is a non-electronic band or bracelet or a dumb band. In some examples, the wristband is an electronic watch. In some examples, the wristband is a smart watch, fitness tracker, activity tracker or connected device. In some examples, the sleeve 410 fits partially around a perimeter of a wristband. A user may slide the sleeve 410 onto a portion of a user item such as a bracelet, watchband, wristband, etc. to convert the item to an electronic wearable device. When coupled with the user item, the inner surface 452 of the electronic sleeve 410 is positioned adjacent to and may circumferentially surround the portion of the user item. The sleeve 410 may also be used when it is not installed around a wristband.

In some examples, the sleeve 410 has only a self-contained camera that is mechanically coupled but not electrically coupled to the sleeve 410. In some examples, the electronic sleeve 410 supports multiple cameras.

In some examples, the electronic sleeve 410 has a battery and coil located on an inside or within the sleeve. In some examples, the sleeve has a coil and a power management chip. The coil may be used for data transmission and/or receipt, and/or to transmit and/or receive wireless power.

In some examples, the electronic sleeve 410 has a continuous width. In some examples, the electronic sleeve 410 is configured to have an adjustable width, so that it may be used with multiple width wristbands, bracelets, watches, etc. In some examples, the electronic sleeve 410 may be releasably coupled to itself via a hook and loop type material, snaps, or other type of releasable coupling.

In some examples, the sleeve may have a gripping element configured to position the sleeve 410 at a specific location on a band. In some examples, the gripping element may be formed using elastic, hook and loop material, metal, plastic, rubber, magnetic, or adhesive material. In some examples, the gripping element may include a protrusion on the sleeve configured to releasable position the sleeve 410 on a band. In some examples, the band may have a corresponding indentation configured to align and position the sleeve 410. In some examples, the gripping element may be formed using an area with a surface having an increased coefficient of friction compared to the band. In some examples, the gripping element may be a mechanical coupling, such as a spring clip, magnet, adjustably strap, and/or elastic.

In some examples, the sleeve 410 may be worn on the arm of a user that is furthest away from the user's thorax side. In some examples, the sleeve 410 may be worn on the arm of a user that is closest to the user's thorax side. In some examples, the sleeve 410 may be worn on a band positioned on a side of a user's arm closest to the user's thorax and a watch face is on a side of a band furthest away from the thorax of the user, or vice versa.

In some examples, the sleeve 410 is configured to transmit data between the electronic wearable device 400 and another electronic device. In some examples, the sleeve 410 is configured to transmit data to and from a user's smart phone, such as indicating a phone call, an alarm, email, etc.

In some examples, the sleeve may have a general footprint size of 35 mm or less width, 75 mm or less length, and 1.0 mm or less width.

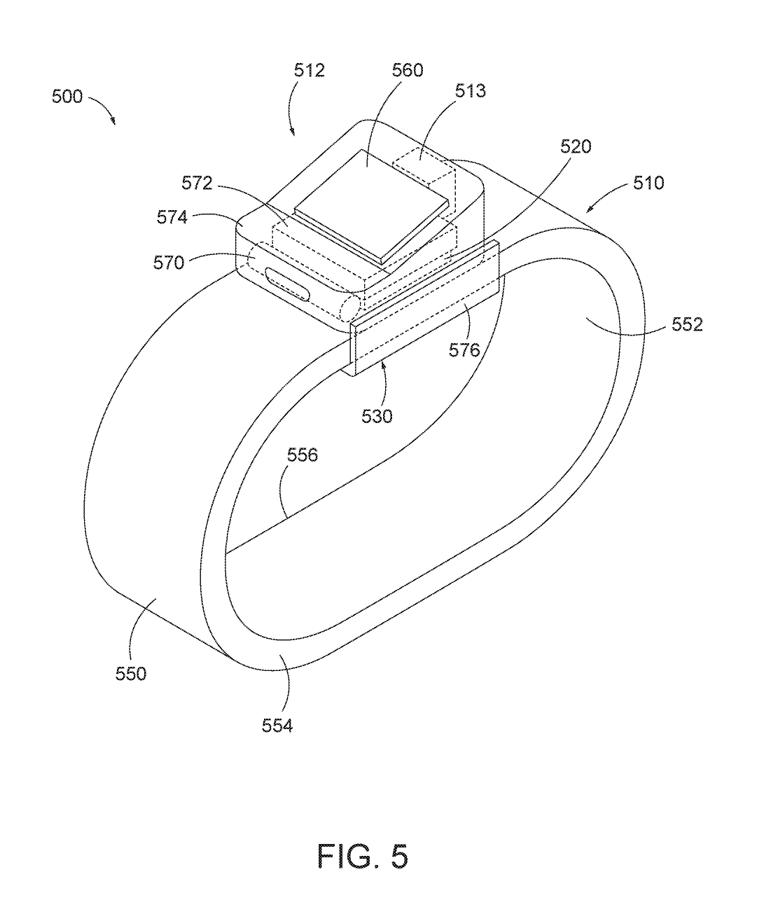

FIG. 5 is a schematic illustration of a first view of another example of an electronic wearable device assembly 500 in the form of a wristband 510 and camera assembly 112 arranged in accordance with examples described herein. In some examples, the electronic wearable device assembly 500 is similar to the electronic wearable device assemblies 100, 200, 300, 400 of FIGS. 1-4. For example, the electronic wearable device 500 may in some examples be used to implement and/or may be implemented by any of the electronic wearable device assemblies 100, 200, 300, 400 of FIGS. 1-4. In some examples, the camera assembly may be an electronic wearable device. The wristband 510 may include or be coupled with a camera assembly 512 having a camera 513, a battery 520, a coupling feature 530, and a screen 560. The camera assembly 512 may also include a wireless charging coil 570, a camera board 572, a camera module 511, and a housing 574 with at least one protrusion 575.

The coupling feature 530 may include a clip 576 configured to adjustably couple the camera assembly 512 with the wristband 510. In some examples the wristband may include a non-electronic watch (e.g. a watch without a processing element, although the watch may have a battery.) In some examples, the wristband is a non-electronic band or bracelet or a dumb band. In some examples, the wristband is an electronic watch. In some examples, the wristband is a smart watch, fitness tracker, activity tracker or connected device. In some examples, the camera assembly 512 positioned adjacent an outer surface 550 of the wristband 510, and the wristband clip 576 is positioned on a first edge 554 and a second edge 556 of the wristband 510. In some examples, the wristband clip 576 extends across a width of the wristband 510, but clips or couples the camera assembly 512. with the wristband 510. For example, the wristband clip 576 is positioned to extend from a portion of the outer surface 550, across the first edge 554, across the width of the inner surface 552, across a second edge 556, and then end at an opposite side of the outer surface 550. In some examples, the clip 576 engages with the protrusion 575 that extends from the housing 574. In some examples, the wristband clip 576 couples to the camera assembly 512 in a manner that compresses the wristband 510 to maintain the position of the camera assembly 512 with respect to the wristband 510.

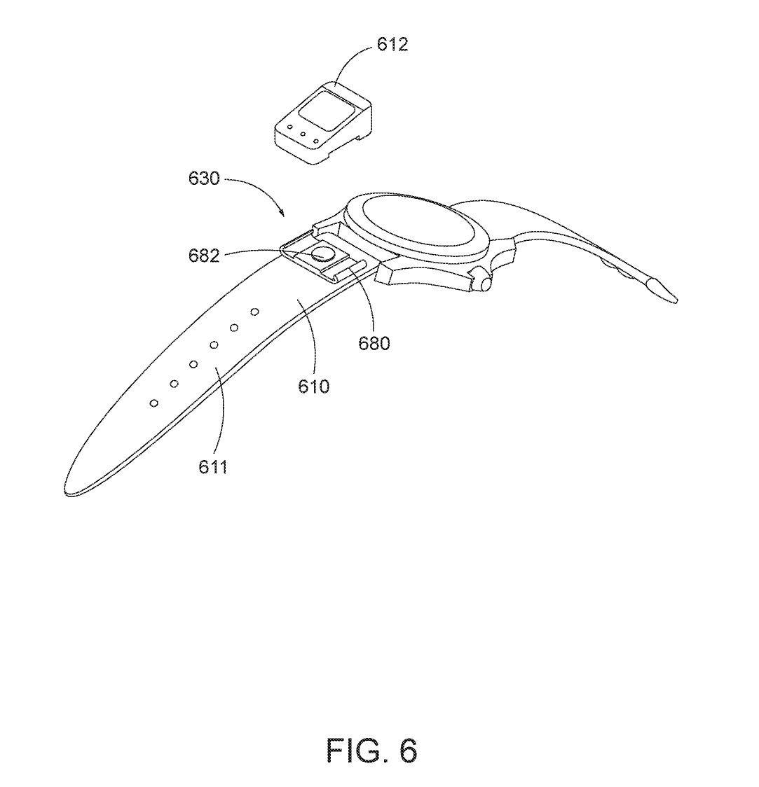

In some examples, the coupling feature 530 including the clip 576 may allow the camera assembly 512 to be adjustably coupled and then removed from a first wristband, watchband, bracelet, etc., and then adjustably coupled to a different wristband, watchband, bracelet, etc. In some examples, the coupling feature has an elastic member. In some examples, the coupling feature has an adjustable strap. In some examples, the coupling feature 530 may also include a magnetic assembly to help align and/or couple the camera assembly 512 and/or the clip 576 and/or the band 510. The magnet may be positioned on or within the housing 574 and may have a corresponding protrusion or indentation configured to adjustably couple with the band 510 and/or the clip 576. The clip 576 may also have a magnet positioned on a surface or within the clip 576 and may have a corresponding a protrusion or indentation to adjustably couple with the camera 512 and/or the band 510. The band 510 may also have a magnet positioned on a surface or within the band 510 and may have a corresponding a protrusion or indentation and may adjustably couple with the clip 576 or the camera 513 or the camera assembly 512. The coupling feature 530 may also allow for the camera 513 to be rotated or adjusted with respect to the band 510 and/or the clip 576. This may allow the camera to be positioned at a variety of photographic objects while on a wristband worn by a user. The user may extend their arm towards a desired photographic object and align and engage the camera and capture an image. In other examples, the user may extend their arm away from them while aiming the camera towards themselves and engage the camera 513 to capture a self-portrait, or a selfie. FIGS. 6-11B may describe additional features of coupling features similar to coupling feature 530.

In the example of FIG. 5, the camera assembly is provided in a wedge form factor.

This may allow the camera 513 to be aimed in a particular direction (e.g., in front of the user) when the user performs a particular gesture. For example, a user may wear the wristband 510 on their left forearm (e.g., wrist). When the user crosses their forearm in front of their body such that their forearm is parallel with the ground when the user is standing and extends from one side of their body to the other, the camera 513 may be pointed in front of the user, so the user may understand that they may capture an image that is in front of them. The screen 560 may in that position also be pointed toward a user's field of view, such that the user may easily review an image on the screen 560 prior to capturing a picture with the camera 513. Any number of activation techniques may be used to capture a picture, including by pressing one or more buttons which may be provided on the camera assembly, or providing a signal (e.g., wired or wireless) to the camera assembly to initiate capture of a picture. Videos may captured by the camera additionally or instead in some examples.

In some examples, the electronic wearable device 500 may be similar to the electronic wearable device assemblies 100, 200, 300, 400 of FIGS. 1-4. The electronic wearable device 500 may in some examples be used to implement and/or may be implemented by any of the electronic wearable device assemblies 100, 200, 300, 400 of FIGS. 1-4. The electronic device may include a camera assembly having a camera and a memory storage, a battery, a level indicator, a Wi-Fi/Bluetooth connection feature, an operational LED, a screen, and a communication or comms component having a speaker and a microphone. In some examples, the device may have an application specific integrated circuit (ASIC) and a sensor package. In some examples, the sensor package may include a variety of sensors such as individual sensor or combination of an accelerometer, acoustic sensor, air pressure sensor, air quality sensor, altimeter, bio sensor. CO sensor, CO2 sensor, electro-mechanical sensor, an EMG sensor, GPS sensor, gyroscope, humidity sensor, infrared sensor, light sensor, mechanical sensor, micro-gyroscope, odor sensor, oxygen sensor, pedometer, pressure sensor, pulse rate sensor, radiation sensor, spectrometer, sweat sensor, temperature sensor, tilt switch, UV sensor, a sensor capable of measuring a base solution, neutral solution, or acidic solution, and/or other sensors. In some examples, the ASIC 462 includes an MCU/MPU. In some examples, the sensor package may include application information and programming configured to calculate a user's caloric expenditures, distance traveled, time slept, and/or quality of sleep.

FIG. 6 is a schematic, exploded illustration of a first view of an example of a camera coupling feature 630 arranged in accordance with examples described herein. In some examples, the coupling feature 630 is similar to the coupling features 130, 230, 330, 430, 530 of FIGS. 1-5. For example, the camera coupling feature 630 may in some examples be used to implement and/or may be implemented by any of the electronic wearable device assemblies 100, 200, 300, 400, 500 of FIGS. 1-5. In some examples, the camera assembly may be considered the electronic wearable device. The coupling feature 630 may adjustably couple a camera assembly 612 to a watch 610 or other type of band. In some examples the band may include a non-electronic watch (e.g. a watch without a processing element, although the watch may have a battery.) In some examples, the band is a non-electronic band or bracelet or a dumb band. In some examples, the band is an electronic watch. In some examples, the band is a smart watch, fitness tracker, activity tracker or connected device. The coupling feature 630 may include a base plate 680 configured to be coupled to a band 611 of the watch 610. A magnet 682 may be positioned between the base plate 680 and the camera assembly 612 to adjustably couple the camera assembly 612 to the band 611 of the watch 610. In some examples, the magnet 682 may be attached to the base plate 680, with a portion of the camera assembly 612 being manufactured with a magnetic or magnetically conductive material that allows the camera assembly 612 to be magnetically attracted to the magnet 682. In other examples, the magnet 682 may be attached to the camera assembly 612, and the base plate 680 may be manufactured with a magnetic or magnetically conductive material which allows the base plate 680 to be magnetically attracted to the magnet 682.

In some examples, the magnet 682 is coupled to a bottom portion of the camera assembly 612. The magnet may extend away from the bottom portion, forming a protrusion. In some examples, a complementary indentation or depression is formed within the base plate 680 and the protrusion of the magnet 682 may be positioned at least partially within the depression when the camera 612 is coupled to the base plate 680. In some examples, the depression of the base plate 680 is formed with a magnet, surrounded by a magnet of formed using a magnetically conductive material.

The coupling feature 630 may also allow the camera assembly 612 to clip, snap, or adjustably engage with the base plate 680. The position of the camera assembly 612 may allow a user to still view the watch face of the watch 610. In some examples, the base plate 680 is integrally formed into the band 611.

In some examples, the camera may be used to take a selfie. For example, the. watch is placed on user's right wrist, the user sticks their right arm straight out to their side; the user bends their right elbow 90 degrees; they move the bent arm back until watch and camera are aligned with their face; and they take a selfie. The process may be modified if the watch is worn on a user's left wrist.

In some examples, the camera assembly 612 may be removed and rotated with respect to the base plate 680 so that the camera is aligned with a different aspect of the watch. This may allow a user to wear the watch on a different wrist and still be configured to capture images of desired photographic objects. In some examples, the base plate 680 may be moved and/or rotated with respect to the band 611 to provide for additional adjustment of the camera 612 location and alignment with various photographic objects. Moving the base plate may be accomplished through mechanical sliding about the band, or alignment with features of the band such as adjustable snapping or clipping, adhesive, hook and loop fasteners, magnetic attraction and the like.

In some examples, the coupling assembly 630 may be similar to the coupling assemblies of the electronic wearable device assemblies 100, 200, 300, 400, 500 of FIGS. 1-5. For example, the coupling assembly 630 may in some examples be used to implement and/or may be implemented by the electronic wearable device assemblies 100, 200, 300, 400, and/or 500 of FIGS. 1-5. In some examples, the camera assembly may be an electronic wearable device. The electronic device may include a camera assembly having a camera and a memory storage, a battery, a level indicator, a Wi-Fi/Bluetooth connection feature, an operational LED, a screen, and a communication or COMMS component having a speaker and a microphone. In some examples, the device may have an application specific integrated circuit (ASIC) and a sensor package. In some examples, the sensor package may include a variety of sensors such as individual sensor or combination of an accelerometer, acoustic sensor, air pressure sensor, air quality sensor, altimeter, bio sensor, CO sensor, CO2 sensor, electro-mechanical sensor, an EMG sensor. GPS sensor, gyroscope, humidity sensor, infrared sensor, light sensor, mechanical sensor, micro-gyroscope, odor sensor, oxygen sensor, pedometer, pressure sensor, pulse rate sensor, radiation sensor, spectrometer, sweat sensor, temperature sensor, tilt switch, UV sensor, a sensor capable of measuring a base solution, neutral solution, or acidic solution, and/or other sensors. In some examples, the ASIC 462 includes an MCU/MPU. In some examples, the sensor package may include application information and programming configured to calculate a user's caloric expenditures, distance traveled, time slept, and quality of sleep.

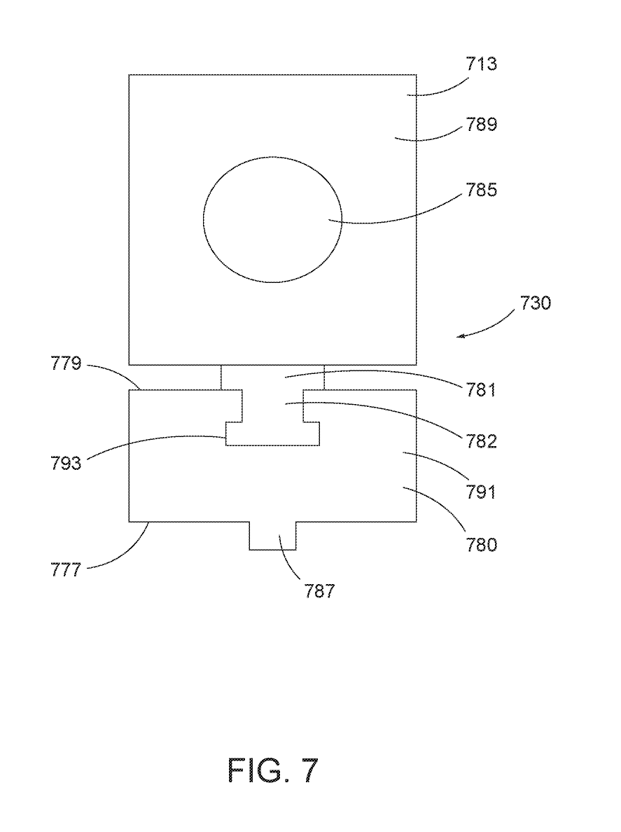

FIG. 7 is a schematic illustration of an example of another camera assembly coupling feature 730 arranged in accordance with examples described herein. In some examples, the coupling feature 730 may be similar to the coupling assemblies of the electronic wearable device assemblies 100, 200, 300, 400, 500 of FIGS. 1-5 and the coupling assembly 630 of FIG. 6. For example, the coupling assembly 730 may in some examples be used to implement and/or may be implemented by the electronic wearable device assemblies 100, 200, 300, 400, and/or 500 of FIGS. 1-5 and the coupling feature 630 of FIG. 6. In some examples, the camera assembly may be an electronic wearable device. In some examples, the camera coupling feature 730 may couple a camera 713 with a base plate 780 of a wristband, watchband, bracelet, ring, etc. In some examples the wristband may include a non-electronic watch (e.g. a watch without a processing element, although the watch may have a battery.) In some examples, the wristband is a non-electronic band or bracelet or a dumb band. In some examples, the wristband is an electronic watch. In some examples, the wristband is a smart watch, fitness tracker, activity tracker or connected device. The camera 713 may include a main body 789, a base coupling member 781, an aperture 785, and a magnet 782. In some examples, the base coupling member 781 extends as a protrusion away from the main body 789. In some examples, the base coupling member 781 of the camera 713 is shaped as an “I”, with a narrow region positioned between two wider regions. In some examples, the base coupling member 781 is a rail. The aperture 785 may be positioned in the middle of the main body 789 and extend through a portion of the length of the main body 789, and may be configured with other components of the camera assembly to capture images.

The base plate 780 may have a main body 791, with a first surface 779 opposite a second surface 777, a member 787, a channel 793, and a magnet 783. In some examples, the channel 793 is adjacent the first surface 779 and extends into the main body 791, towards the second surface 777.

The member 787 of the base plate 780 may be formed as a protrusion that extends away from the second surface 777 and the main body 791, opposite the channel 793.

The base coupling member 781 of the camera 713 may be configured to slide, fit, snap, or adjustably couple with the channel 793 of the base plate 780. In some examples, the channel 793 may be generally rectangular shaped to complement the shape of the base coupling member 781 of the camera 713. In some examples, the channel 793 may be shaped to allow for a bottom, wider portion of the base coupling member 781 to slide within the channel 793. In some examples, the channel 793 is configured as a track.

In some examples, the magnet 782 may be positioned adjacent to or installed within the main body 789 of the camera 713. In some examples, the base plate magnet 783 may be installed within or adjacent to the main body 791 of the base plate 780 or within the channel 793 of the base plate 780. The camera magnet 782 may attract the base plate magnet 783 to help adjustably couple the base plate 780 and camera 713 together, forming the coupling feature 730.

The member 787 of the base plate 780 may be configured to rotatably couple the base plate 780 with the band, wristband, watchband, bracelet, or ring of an associated electronic wearable device. In some examples, the member 787 is adjustably and rotatably coupled to a receiving member of the band, wristband, watchband, bracelet, or ring of an associated electronic wearable device. The member 787 may allow for the camera 713 to be adjustably rotated with respect the wearable device. In some examples, the member 787 slidably couples with the receiving member and allows for adjustable rotation. In some examples, the member 787 snaps together with the receiving member and allows for adjustable rotation.

In some examples, the member 787 is magnetically ed with the receiving member and allows for adjustable rotation.

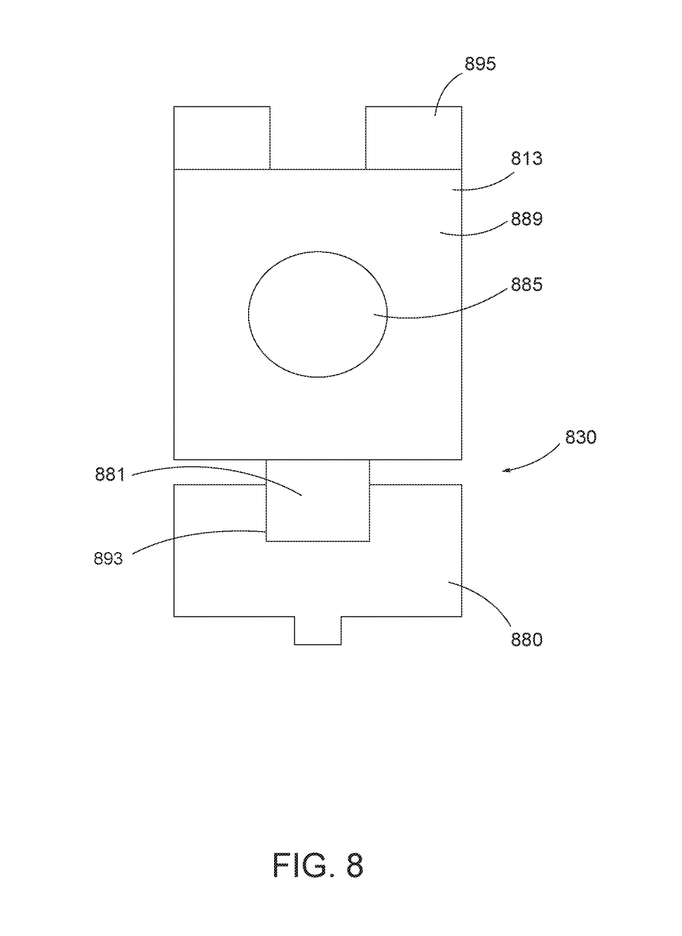

FIG. 8 is a schematic illustration of another example of a camera coupling feature 830 arranged in accordance with examples described herein. In some examples, the coupling feature 830 may be similar to the coupling assemblies of the electronic wearable device assemblies 100, 200, 300, 400, 500 of FIGS. 1-5 and the coupling features 630, 730 of FIG. 6-7. For example, the coupling assembly 830 may in some examples be used to implement and/or may be implemented by the electronic wearable device assemblies 100, 200, 300, 400, and/or 500 of FIGS. 1-5 and the coupling features 630, 730 of FIGS. 6-7. In some examples, the camera assembly may be an electronic wearable device. In some examples, a camera 813, a camera coupling feature 830, and a base plate 880 of FIG. 8 are similar to the camera 713, camera coupling feature 730, and base plate 780 of FIG. 7. The camera 813 may also include a sight 895 positioned on a surface of a main body 889 of the camera 813. In some examples, the sight 895 is aligned with an aperture 885 to allow a user to view a photographic object through the sight 895 to properly align the aperture 885 to capture an image of the photographic object. In some examples, the sight 895 may be a channel, with an opening directed away from the main body 889. In some examples, the sight 895 may be an aperture or indentation extending through a portion of the main body 889.

In some examples, a base coupling member 881 of the camera 813 may be formed as a rectangle, as opposed to the “I” shaped of the base coupling member 781 of FIG. 7. A channel 893 of the base plate 880 may be formed to complement the shape of the base coupling member 881 so that the camera 813 and base plate 880 may be adjustably coupled together. In some examples, the coupling member 881 slides within or adjacent to the channel 893 of the base plate 880.

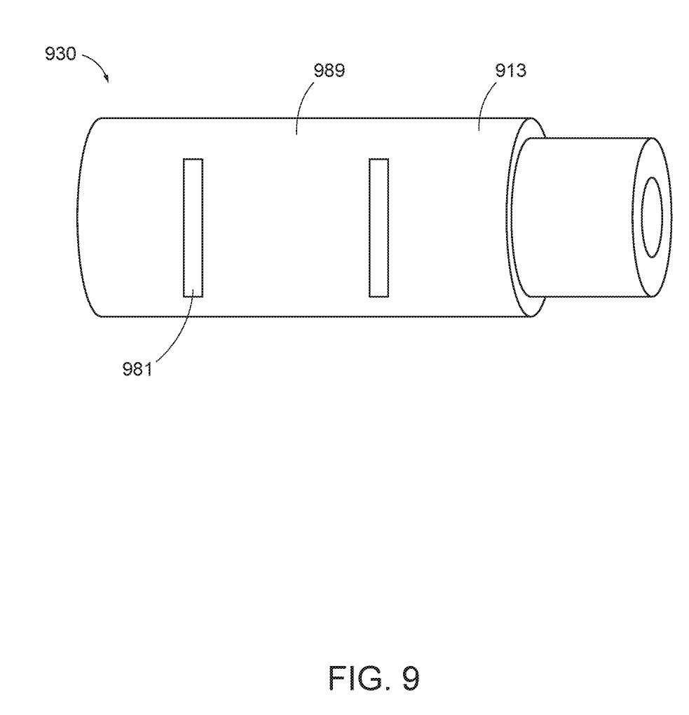

FIG. 9 is a schematic illustration of another example of a portion of a camera coupling feature 930 arranged in accordance with examples described herein. In some examples, the coupling feature 930 may be similar to the coupling assemblies of the electronic wearable device assemblies 100, 200, 300, 400, 500 of FIGS. 1-5 and the coupling features 630, 730, 830 of FIG. 6-8. In some examples, the camera assembly may be an electronic wearable device. For example, the coupling assembly 930 may in some examples be used to implement and/or may be implemented by the electronic wearable device assemblies 100, 200, 300, 400, and/or 500 of FIGS. 1-5 and the coupling features 630, 730, 830 of FIGS. 6-8. A camera 913 may have a base coupling feature 981 that helps form the camera coupling feature 930. In some examples, the camera coupling feature 930 is configured to couple a camera 913 to a base plate of a band, watchband, wristband, bracelet, or ring, such as an item similar to the wristband 110 of FIG. 1, the ring 210 of FIG. 2, the watch 310 of FIG. 3, the electronic sleeve 410 of FIG. 4, the wristband 510 of FIG. 5, and the watch 610 of FIG. 6. In some examples, the base coupling feature 981 may have at least one protrusion extending away from the main body 989 of the camera 913 and configured to align or mate with a feature in the base plate, such as a channel, aperture, indentation, recessed area, etc. In some examples, the base coupling feature 981 may be an indentation or channel formed in the main body 989 of the camera 913 and configured to align or mate with a raised or protruding feature in the base plate.

In some examples, the coupling feature 981 includes a spring loaded element, such as a pin or bearing, configured to compress and expand, thereby adjustably engaging with features of the camera and the wristband In some examples, the camera 913 may be configured to utilize a spring loaded element such that the camera may be stored in a storage position wherein the spring loaded element is compressed and the camera is not positioned or configured for image capture, and in a use positon where the spring loaded element is expanded and the camera is positioned or configured for image capture.

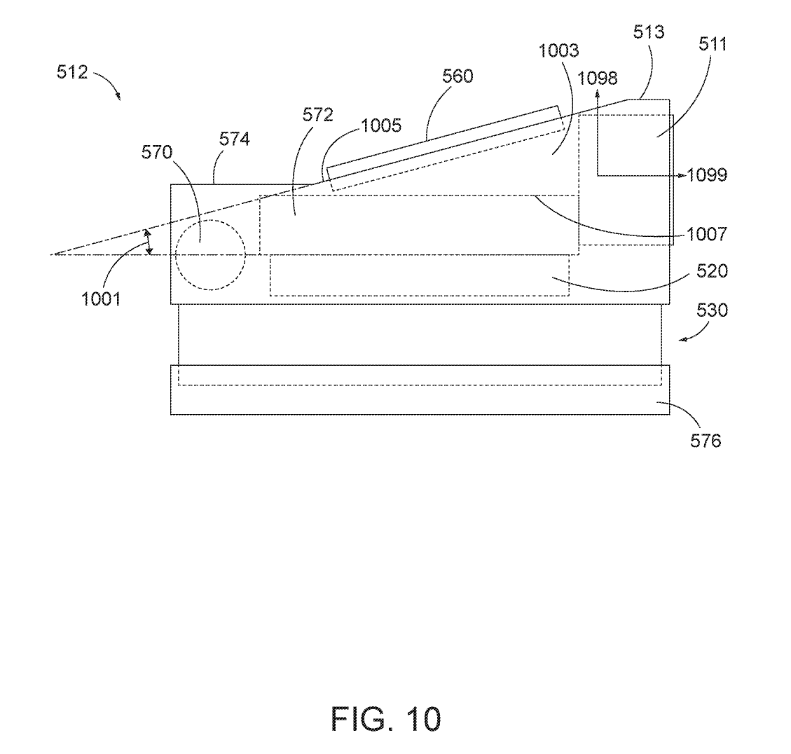

FIG. 10 is a schematic illustration of another view of the camera coupling feature 530 of FIG. 5 arranged in accordance with examples described herein. In some examples, the camera assembly 512. may include the camera 513 having the camera module 511 with a horizontal aspect 1099 and a vertical aspect 1098, the camera board 572, the display or screen 560, the housing 574, the wireless charging coil 570, and the battery 520. The camera assembly 512 may be coupled to the wristband band clip 576. The wristband clip may form part of the coupling feature 530 that couples the camera assembly 512 to the wristband 510,

In some examples, the camera assembly 512 may have a wedge 1003 having a top surface 1005 and a bottom surface 1007. The top surface 1005 of the wedge 1003 may support the screen 560 at an angle 1001 above the camera board 572. In some examples, the camera board 572 and camera module 511 may be generally planar with each other and planar with the wristband clip 576 and the horizontal aspect 1099 of the camera module 511. The angle 1001 of the wedge 1003 may allow for the screen 560 to be angled with respect to the horizontal aspect 1099 of the camera module 511, which may be configured to align with the desired photographic object. The resulting angled screen 560 may make it easier for a user to align the camera module 511 with the desired photographic object, while using the screen 560 as a viewfinder to understand the alignment of the camera module 511 with the photographic object and adjust the position of the camera assembly 512 accordingly. In some examples, the angle 1001 is acute. In some examples, the angle 1001 is generally in a range between about 10 and 80 degrees, In some examples, the angle 1001 is generally in a range between about 10 and 30 degrees. In some examples, the angle 1001 is generally in a range between about 30 degree to 50 degrees. In some examples, the angle 1001 is generally in a range between about 50 and 70 degrees. In some examples, the angle 1001 is generally about 90 degrees.

In some examples, the screen 560 is separable from the camera assembly 512.

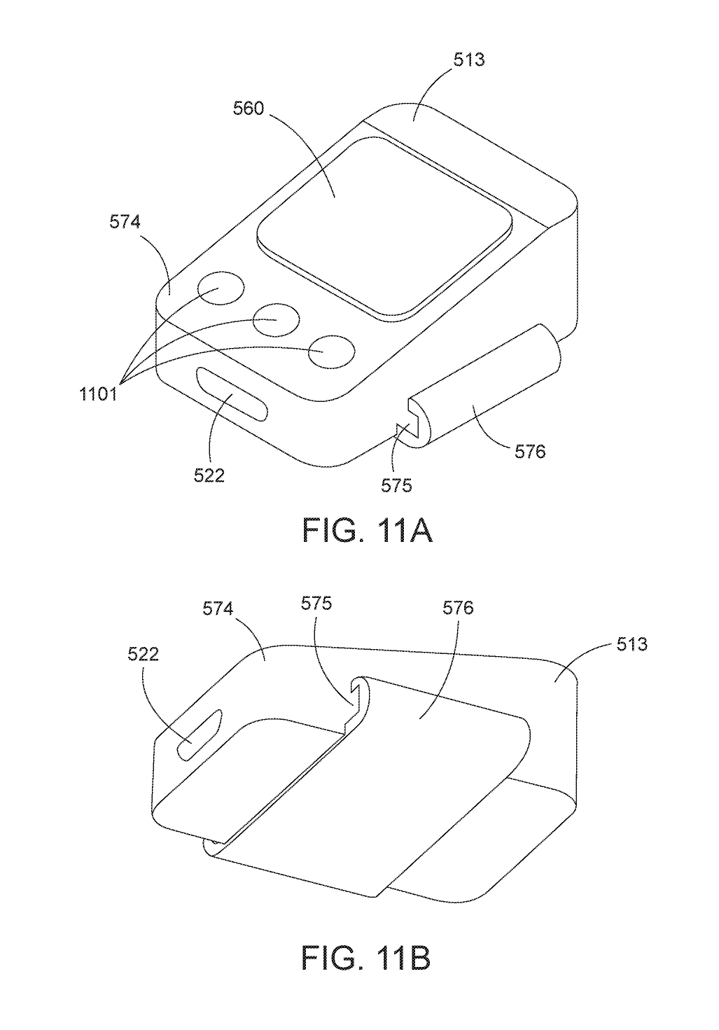

FIGS. 11A and 11B are a top and bottom isometric schematic illustration of various components of the camera coupling feature of FIG. 5 arranged in accordance with examples described herein. FIGS. 11A and 11B show the camera 513, screen 560, micro USB connector 522, and housing 574 with the wristband clip 576 without showing the strap, wristband, or the like. The camera 513 may also have user inputs 1101 that allow a user to adjust aspects of the camera assembly 512.

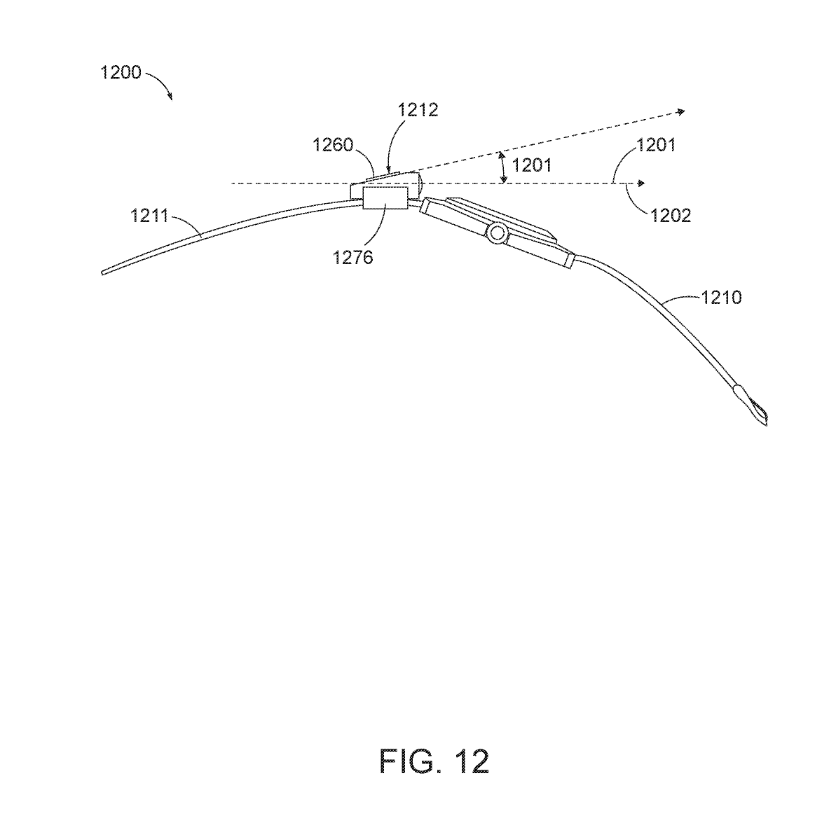

FIG. 12 is a schematic, non-exploded illustration an electronic wearable device 1200 in the form of a watch 1210 arranged in accordance with examples described herein. The electronic wearable device 1200 is similar to the electronic wearable device 500 of FIG. 5. A camera assembly 1212 and a wristband clip 1276 are similar to the camera assembly 512 and wristband clip 576 of FIG. 5. FIG. 12 also shows a line of sight 1202 of the camera assembly 1212, as positioned on a strap 1211 of the watch 1210. An acute angle 1201 is formed between a plane traveling through a display or screen 1260 and the line of sight 1202. The line of sight 1202 may travel through a camera module (similar to the camera module 511 of FIG. 10) to capture an image aligned with the line of sight 1202. The angle 1201 may allow for the screen 1260 to be elevated at an angle 1201 towards a user. This may make it easier for a user to align the camera assembly 1212 with a desired photographic object while still using the screen 1260 as a viewfinder.

In some examples, an electronic wearable device and/or coupling feature may have a combination of features from the devices shown in FIGS. 1-12. The camera assemblies of FIGS. 1-12 may each be configured to capture high definition (HD) video with audio. The camera assemblies of FIGS. 1-12 may be each configured to capture high definition (HD) photos.

The above detailed description of examples is not intended to be exhaustive or to limit the method and system for wireless power transfer to the precise form disclosed above. While specific embodiments of, and examples for, the method and systems for wireless power transfer are described above for illustrative purposes, various equivalent modifications are possible within the scope of the system, as those skilled in the art will recognize. For example, while processes or blocks are presented in a given order, alternative embodiments may perform routines having operations, or employ systems having blocks, in a different order, and some processes or blocks may be deleted, moved, added, subdivided, combined, and/or modified. While processes or blocks are at times shown as being performed in series, these processes or blocks may instead be performed in parallel, or may be performed at different times. It will be further appreciated that one or more components of base units, electronic devices, or systems in accordance with specific examples may be used in combination with any of the components of base units, electronic devices, or systems of any of the examples described herein.

1. An electronic wearable device comprising:
a base plate configured to be selectively attachable to a plurality of wristbands;
a camera assembly configured to be selectively attachable to the base plate, wherein the camera assembly is configured to capture image data, video data having an audio component, or both.

2. The device of claim 1, wherein the camera assembly is configured to magnetically attach to the base plate.

3. The device of claim 1, wherein the camera assembly is configured to be pointed in a direction away from a user to capture an image of a distant removed object.

4. The device of claim 1, wherein the camera assembly is configured to be pointed in a direction towards a user to capture a selfie of the user.

5. The device of claim 1, wherein an elastic member attaches the base plate to the wristband.

6. The device of claim wherein an adjustable strap attaches the base plate to the wristband.

7. The device of claim 1, wherein the camera assembly further comprises a top surface and a bottom surface, wherein a first plane traveling through the top surface forms angle with a second plane traveling through the bottom surface.

8. The device of claim 1, wherein the camera assembly further comprises a display surface and a bottom surface, wherein a first plane traveling through the display surface forms an angle with a second plane traveling through the bottom surface.

9. The device of claim 1, further comprising an electronic display configured to display an image collected at least in part by the camera assembly.

10. The device of claim 1, further comprising a communication system configured to communicate data to the camera assembly, from the camera assembly, or both.

11. The device of claim 1, wherein the camera assembly is configured to wirelessly connect with a mobile computer device, a smart phone, or both.

12. The device of claim 1, wherein the camera assembly further comprises a touch sensitive electronic display configured to display options for control of the camera assembly.

13. The device of claim 1, wherein the camera assembly is configured to receive and display an alert message, a text message, a time of day, a weather forecast, an ambient temperature, a geolocation, a distance traveled, a quantity of steps traveled, an image captured by the camera assembly, an image received from another computing system, or combinations thereof.

14. The device of claim 1, wherein the camera assembly is configured to capture an image responsive to a touch of a display coupled to the camera assembly.

15. The device of claim 1, wherein the camera assembly is configured to capture an image responsive to a touch of the camera assembly.

16. The device of claim 1, wherein the camera assembly is configured to turn on responsive to a wrist movement of a user.

17. The device of claim 9 , wherein the camera assembly is configured to wirelessly transmit a captured image to a mobile computer device, to a smart phone or both.

18. The device of claim 1, wherein the camera assembly is configured to respond to a voice command.

19. The device of claim 1, wherein the camera assembly is configured to communicate an audio signal.

20. The device of claim 1, wherein the camera assembly is configured to attach to the wristband and the wristband is a wristband of a watch, a smart watch, an activity tracker, a fitness tracker, or combinations thereof.

21. The device of claim 1, further comprising a communication component having a microphone and a speaker.

22. The device of claim 1, further comprising a screen configured to display a first and a second statistic of the camera assembly.

23. The device of claim 1, wherein the wristband is a wristband configured to be positioned around a user's wrist.

24. The device of claim 1, wherein the wristband is a ring configured to be positioned around a user's finger.

25. The device of claim 1, wherein the wristband is a watchband with a watch face and configured to be positioned around a user's wrist.

26. The device of claim 1, further comprising a sensor package.

27. The device of claim 26, wherein a sensor package comprises at least one of an accelerometer, a gyroscope, and a pulse sensor.

28. The device of claim 1, further comprising a connection feature configured to connect the device to an alternate electronic device via a wireless internet signal or a Bluetooth signal.

29. An electronic wearable device comprising:
a camera assembly having a wedge with a top surface and a bottom surface, a housing, and a camera module having a horizontal aspect, a vertical aspect, and a sightline generally parallel to the horizontal aspect, wherein the top surface of the wedge forms an acute angle with the sightline;
a coupling feature comprising a clip configured to adjustably couple to the housing of the camera assembly;
wherein the coupling feature and the camera assembly are configured to couple together about a band.

30. The device of claim 29, wherein the housing further comprising at least one protrusion that is configured to adjustably couple with the clip.

31. The device of claim 29, wherein the camera assembly further comprises a screen adjacent the top surface of the wedge, and the screen is configured to display a view of a photographic object as positioned within the sight line of the camera module.

32. The device of claim 29, wherein the acute angle is in the range of about 10 degrees to 80 degrees as measured from the sightline.

33. The device of claim 29, wherein the acute angle is in the range of about 20 to 60 degrees as measured from the sightline.

34. The device of claim 29, wherein the wristband is a watchband.

35. The device of claim 29, wherein the wristband is a bracelet.

36. The device of claim 29, wherein the wristband is a ring configured to be worn around a user's finger.

37. The device of claim 29, wherein the camera assembly further comprises a micro USB connector port.

38. The device of claim 29, wherein the camera assembly further comprises a camera module configured to electronically capture a photographic image, and a flash aligned with the camera module.

39. The device of claim 29, wherein the coupling feature comprises a first magnetic member in the housing that attracts a second magnetic member of the clip,

40. The device of claim 29, wherein the coupling feature comprises a first magnetic member in the housing that attracts the clip.

41. The device of claim 29, wherein the coupling feature comprises a first magnetic member in the clip that attracts the housing.
